(19) United States
(12) Patent Application Publication
(10) Pub. No.: US 2013/0332348 A1
(43) Pub. Date: Dec. 12, 2013

(54) SYSTEM AND METHOD FOR PROXY SHOPPING THROUGH MULTIPLE PAYMENTS

(71) Applicants: Joon Goo Lee, Seoul (KR); One June Ham, Seoul (KR)

(72) Inventors: Joon Goo Lee, Seoul (KR); One June Ham, Seoul (KR)

(21) Appl. No.: 13/980,816

(22) PCT Filed: Jan. 6, 2012
(86) PCT No.: PCT/KR2012/000141

§ 371 Date: Aug. 20, 2013

(30) Foreign Application Priority Data
Jan. 21, 2011 (KR) 10-2011-0006362

(51) Int. Cl. G06Q 20/22

(52) U.S. Cl. CPC G06Q 20/29
USPC 705/39

(57) ABSTRACT

The present invention relates to a system and method for proxy purchasing through multiple payments, in which a user informs multiple participants of an intention to purchase designated predetermined goods through a social network, and the predetermined goods can be provided to the user through proxy payment for the goods by collecting partial payments from the multiple participants. The proxy purchasing system and method through multiple payments according to the present invention enables a potential buyer to purchase desired goods for free or at a low price through partial payments from a plurality of unspecified persons, thus providing the effect of alleviating the burden on a potential purchaser requesting a gift and a payer providing a partial payment.

### CROSS-REFERENCE TO RELATED APPLICATION

This application claims the benefit of Korean Application No. 10-2011-0006362, filed on Jan. 21, 2011, with the Korean Intellectual Property Office, the disclosure of which is incorporated herein by reference.

### BACKGROUND OF THE INVENTION

1. Field of the Invention

The present invention relates to a system and method for proxy shopping through multiple payments, in which a user informs multiple participants of an intention to purchase designated predetermined goods through a social network, and the predetermined goods can be provided to the user through proxy payment for the goods by collecting partial payments from the multiple participants.

2. Description of the Related Art

With the emergence of a variety of communications systems and the routinization of on-line environments, on-line advertisements, sales and payments for many different kinds of goods have been ubiquitous and the stability and diversity of such on-line advertisements, sales and payments continue to be improved.

As current on-line goods sales and advertising have been developed from the way to accommodate properties of off-line in on-line, a form in which a single purchaser reveals purchase intention for goods being sold in an on-line shopping mall and gets a delivery of the goods by paying for the goods through on-line payment has been changed to a form in which goods of different sellers registered in an on-line open market constructing environments similar to those of an off-line market can be selectively purchased by a subscriber visiting the open market. In recent years, there has been proposed various services which compare prices of various kinds of goods included in different open markets and on-line shopping malls and associate purchase wishers with the open markets and on-line shopping malls based on a result of the comparison.

However, the present goods (including services) sales and payments are limited to the form in which purchasers can receive the goods or services after paying all costs for the goods or services. That is, all payment amounts have to be paid at the time of purchase, except installment transactions which, however, correspond to payment all costs by the purchasers since the installment transactions are also substantial credits promising to pay all costs. Of course, a variety of points, coupons, discounts and so on may be used, but since they are also, in fact, goods belonging to the purchasers, the fact that the purchasers have to pay all costs is unchanged.

FIG. 1 is used to explain a goods trading way in the general open market, in which an open market 10 provides a service which allows a plurality of subscribed sellers 11 to list and search registered goods and allows purchasers 43 subscribed as members to perform integrated purchasing management and electronic payment. Through this service, the purchasers 43 accessed the open market 10 via a communication network 12 confirm and decide to purchase goods in the open market 10 based on the confidence of the open market even with no confidence to the sellers 11.

FIG. 2 shows an example of service allowing a purchaser subscribed in a portal site 30 to perform purchasing management and payment even without subscribing in a plurality of interlocked on-line shopping malls separately. Through this service, the on-line shopping malls can attract purchasers 23 while maintaining their non-standardized individual properties and the purchasers 23 can purchase goods of the on-line shopping malls 21 based on the confidence to the portal site 20 and the convenience of integrated purchasing management.

FIG. 3 shows an example of an affiliate site 30 which provides information on goods of various open markets 31 and on-line shopping malls 32 to purchasers 34 and offers rewards to the purchasers 34 who purchased goods based on the information. As shown, this affiliate site 30 provides a service allowing the purchasers 34 subscribed in the affiliate site 30 to utilize the rewards offered from the affiliate site 30 as a portion of purchase cost when the purchaser 34 purchase goods of a seller related to the affiliate site 30.

In addition to the goods and service selling and purchasing way and its associated service shown in FIGS. 1 to 3, there have been proposed different ways to connect various goods and purchasers. For example, there are a social commerce to utilize recent rapidly spreading social networks for goods advertising and purchase, a combination of a portal site including the existing shopping mall function and a social network, etc. Through these ways, purchasers can purchase better goods with more ease and convenience and, in some case, can receive various discounts and rewards, thereby attracting their high interest.

However, the social commerce shown in FIGS. 1 to 3 as well as emerging social commerce has limitations of traditional payment in that purchasers can receive goods and services only when they incur their own money and credit for the corresponding goods and services in all purchases.

A large part of various purchasing ways related to goods involve gifts or donations. However, with regard to a specific goods, product for the products of the product to request a gift more expensive even if it is hard to easily request the request, the recipient may be too much of a burden. In particular, various traditional payment methods as described earlier force purchasers to use their own money to pay all costs for goods or services. Thus, there exists no current method to enable partial payment for only a portion of specific purchase costs.

Merely, there may exist a method of partially providing cash or corresponding goods which can be used to purchase unspecified goods. For example, as shown in FIG. 4, cyber money can be mutually exchanged among users 41 and 42 belonging to a group 40 which can deal with the same cyber money having cashability, such as a particular social group or site, but in which case there is an impossibility of direct exchange of the cyber money with a user 43 not belonging to the group. In addition, this method involves direct delivery of cash or equivalent cashable goods (for example, gift certificates), which is unsuitable for gifts and donations limited to specified goods or services.

In other words, even when a user requests a portion of purchase cost to purchase goods desired by the user, it is hard to confirm whether or not the goods is actually purchased if cashable goods is directly provided. This may undercut a meaning of gift giving and makes it difficult to obtain the trust of a donator for donation.

In particular, under a circumstance where illegality of a donation administrator is being reported through media, it is reluctant to directly donate goods that the donation administrator may arbitrarily dispose of. In addition, it is hard to confirm how the donation of the donator is used, which may result in low satisfaction of the donator and difficulty in inducing donation. Even so, direct purchase and delivery of a meaningful level of goods by a donator impose a burden in terms of costs and time, which may result in difficulty in activating donation culture.

In the end, there is a need for novel payment system other than the above-described traditional payment for goods purchase and direct delivery of unspecifiable goods.

### SUMMARY OF THE INVENTION

In order to overcome the above problems of the traditional on-line payment method, it is an object of embodiments of the present invention to provide a proxy purchasing system and method through multi-payment, which is capable of allowing a purchase wisher to purchase goods at no or low cost through partial payments of unspecified individuals by generating a shared item including registered contents for the goods (or services) to be purchased by the purchase wisher and a multi-payment interface, causing the shared item with a social network, and using money partially paid by the unspecified individuals through the multi-payment interface included in the shared item for goods purchase.

It is another object of embodiments of the present invention to provide a proxy purchasing system and method through multi-payment, which is capable of providing a high possibility of goods purchase with an increased proportion of participation in partial payment by easily spreading a shared item generated to include a multi-payment interface by goods registration of a purchase wisher through a social network in an acquaintance-based manner, alleviating a burden on participation by setting a partial payment system in various ways, and allowing a payer to explicitly confirm a result of payment by the payer by informing payment participants of a result of goods purchase.

It is another object of embodiments of the present invention to provide a proxy purchasing system and method through multi-payment, which is capable of improving convenience of registration by easily acquiring contents related to goods to be purchased by a purchase wisher from the existing goods sales environments and generating a shared item, and minimizing inconvenience of the purchase wisher and a payer by diversifying a payment method for the payer and progressing payment simply and conveniently even if the payer does not belonging a particular group or without requiring a procedure such as membership joining.

It is another object of embodiments of the present invention to provide a proxy purchasing system and method through multi-payment, which is capable of performing a novel acquaintance-based advertisement function by generating a shared item for goods to be purchased by a purchase wisher, sharing the shared item including a message such as description on the goods, purchase motivation and so on through a social network and sharing contents added with an analysis on the goods, purchase motivation and so on with the social network.

It is another object of embodiments of the present invention to provide a proxy purchasing system and method through multi-payment, which is capable of providing a high level of satisfaction of payment participants, high quality contents of a social network and a high level of goods awareness by allowing a purchase wisher to provide a postscript, certified photos, utilized photos, usage explanation and so on for goods or service, as a reward for purchase of the goods or services as a result of multi-payment for a shared item shared by the purchase wisher.

To achieve the above objects, according to an aspect of the invention, there is provided a system for proxy purchasing through multi-payment including: a goods managing part which receives information on a purchase object, registers the information, and manages a history for the object; a multi-payment providing part which accumulates partial payments of multiple payers for the purchase object registered in the goods managing part and performs purchase for the purchase object; an interface providing part which generates purchase object information registered in the goods managing part and shared item information including an interface for the multi-payment providing part; an item sharing part which provides the shared item information provided through the interface providing part in a format which can be shared in a social network; and a multi-payment service managing part which delivers information provided through the above parts and reads/writes related information from/into an internal or external database.

The goods managing part may use an Open API of a service provider platform providing a commerce service for the purchase object to obtain information on a selected purchase object or may provide an input webpage which receives the information on the purchase object.

The goods managing part may acquire the object information from a service provider screen providing a commerce service for the object through one of various ways including widgets, toolbars, multiple frames, links and mobile applications and may provide pre-registered contents for the object.

The goods managing part may provide at least one of payment-related settings including a payment method for multi-payment for the purchase object, payment limit money and target money, and at least one of description input means including a specification of the purchase object, description on the purchase object and a message to be delivered to payers.

The multi-payment providing part may pay preset money or money set by a payer through at least one of credit payment, charge-integrated payment of communication or broadcasting means, cyber money or point payment, on-line transfer, bank account transfer and coupon payment.

The multi-payment providing part may notify or inform payers, who participate in multi-payment for the purchase object, of information on completion of purchase for the purchase object.

The item sharing part may provide the shared item generated in the interface providing part in at least one of formats including a link, a tag, an image including a link, a flash, an XML, a widget and a webpage in proper matching in accordance with a limitation on the type of social networks to share the shared item.

The goods managing part may further include a setting portion which receives a kind of reward to be provided to a payer for purchase of the object when the purchase object is registered, and confirms whether or not the reward is made based on a result of the purchase of the multi-payment providing part.

The multi-payment service managing part may acquire preset advertisement information for the purchase object, provide condition information on advertisement in goods registration through the goods managing part, and set payment environments by providing the condition information to the multi-payment providing part.

The multi-payment providing part may collect sharing state information of the shared item and change the payment environments based on the condition information for the advertisement.

The goods managing part may provide a means for varying, for the same goods, a service provider or a seller providing a commerce service for the purchase object.

According to another aspect of the invention, there is provided a system for proxy purchasing through multi-payment including: a goods managing part in which goods information including sales information on purchase wish goods and message information of a purchase wisher; a multi-payment providing part which accumulates payments of partial money for goods registered through the goods managing part and performs payment for the goods when the accumulated partial money reaches target money or there is a selection of the purchase wisher; and an interface providing part which provides shared item information including a portion of goods information registered through the goods managing part and an interface for the multi-payment providing part in a format which can be shared in a preset kind of social network.

According to another aspect of the invention, there is provided a method for proxy purchasing through multi-payment including: a goods registering step of receiving and registering, as goods information, goods content wished for purchase through an account of a purchase wisher and set information designated by the purchase wisher; an item generating step of generating a shared item by combining a multi-payment interface performing partial payment for the goods registered through the goods registering step with the goods information; an item sharing step of providing the generated shared item in a format which can be shared through a preset kind of social network; and a payment step of accumulating partial payments through the multi-payment interface included in the shared item and making proxy purchase for the goods when the accumulated partial payments reach a goal or at a point of time desired by the purchase wisher.

The item sharing step may include exposing multiple goods, which are registered in the goods registering step through a single shared item shared in the social network, according to a preset exposure method.

The present invention has an advantage in that a proxy purchasing system and method through multi-payment is capable of allowing a purchase wisher to purchase goods at no or low cost through partial payments of unspecified individuals by generating a shared item including registered contents for the goods (or services) to be purchased by the purchase wisher and a multi-payment interface, causing the shared item with a social network, and using money partially paid by the unspecified individuals through the multi-payment interface included in the shared item for goods purchase, thereby alleviating a burden on a purchase wisher requesting a gift and a payer providing a partial payment.

The present invention has another advantage in that a proxy purchasing system and method through multi-payment is capable of providing a high possibility of goods purchase with an increased proportion of participation in partial payment by easily spreading a shared item generated to include a multi-payment interface by goods registration of a purchase wisher through a social network in an acquaintance-based manner, alleviating a burden on participation by setting a partial payment system in various ways, and allowing a payer to explicitly confirm a result of payment by the payer by informing payment participants of a result of goods purchase.

The present invention has another advantage in that a proxy purchasing system and method through multi-payment is capable of improving convenience of registration by easily acquiring contents related to goods to be purchased by a purchase wisher from the existing goods sales environments and generating a shared item, and minimizing inconvenience of the purchase wisher and a payer by diversifying a payment method for the payer and progressing payment simply and conveniently even if the payer does not belonging a particular group or without requiring a procedure such as membership joining.

The present invention has another advantage in that a proxy purchasing system and method through multi-payment, which is capable of performing a novel acquaintance-based advertisement function by generating a shared item for goods to be purchased by a purchase wisher, sharing the shared item including a message such as description on the goods, purchase motivation and so on through a social network and sharing contents added with an analysis on the goods, purchase motivation and so on with the social network, thereby providing an effect of exploitation of new advertisement markets.

The present invention has another advantage in that a proxy purchasing system and method through multi-payment, which is capable of providing a high level of satisfaction of payment participants, high quality contents of a social network and a high level of goods awareness by allowing a purchase wisher to provide a postscript, certified photos, utilized photos, usage explanation and so on for goods or service, as a reward for purchase of the goods or services as a result of multi-payment for a shared item shared by the purchase wisher.

### BRIEF DESCRIPTION OF THE DRAWINGS

FIG. 1 shows an example of an electronic commerce system using an open market.

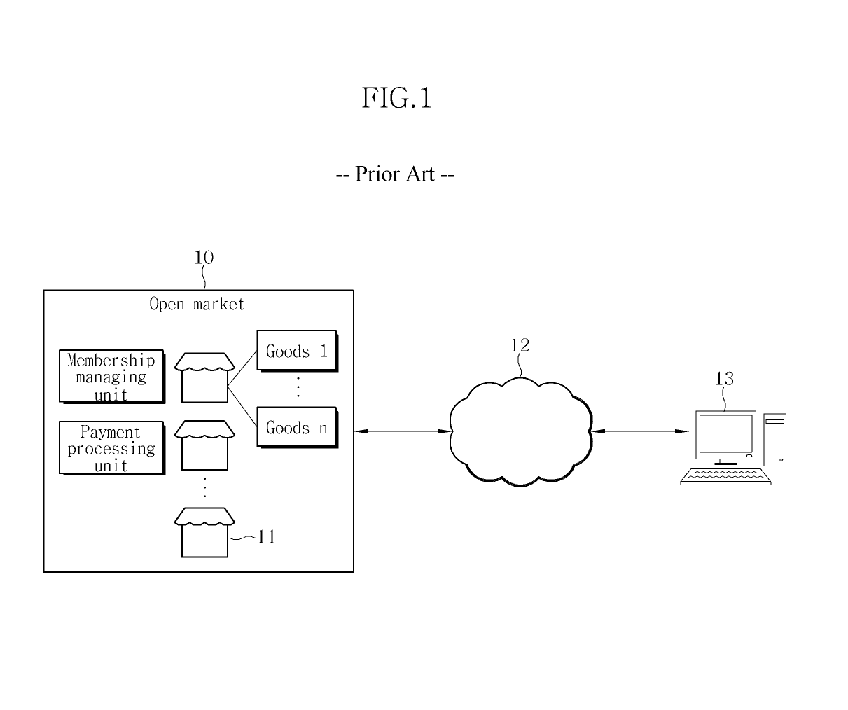

FIG. 2 shows an example of electronic commerce configuration of a shopping mall management system through a portal site.

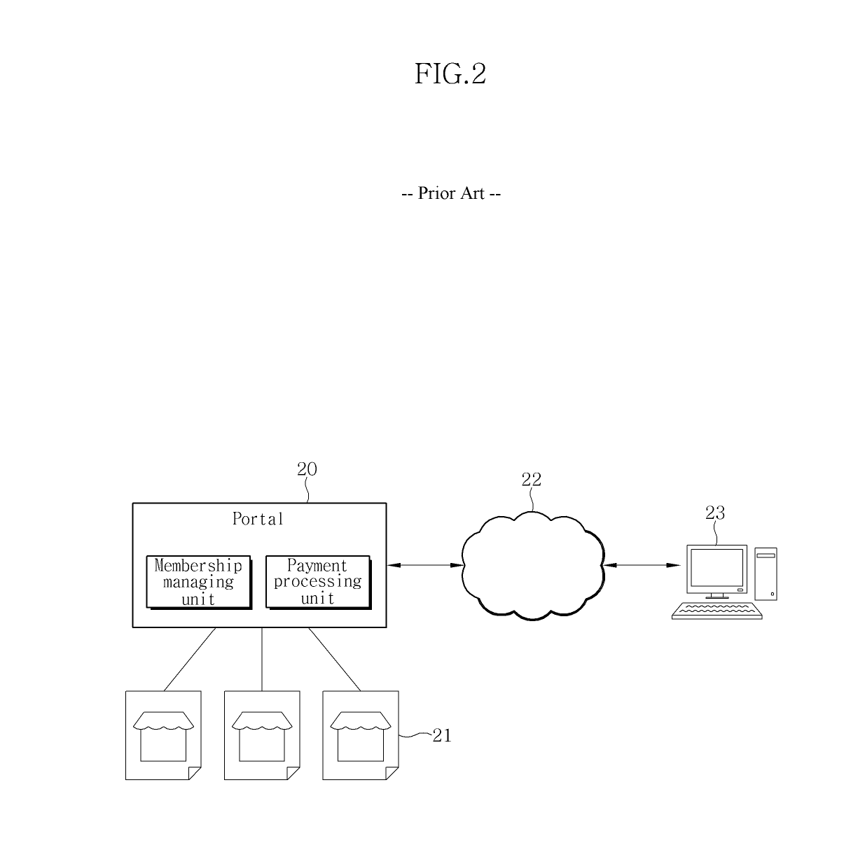

FIG. 3 shows an example of a reward provision configuration through an affiliate site.

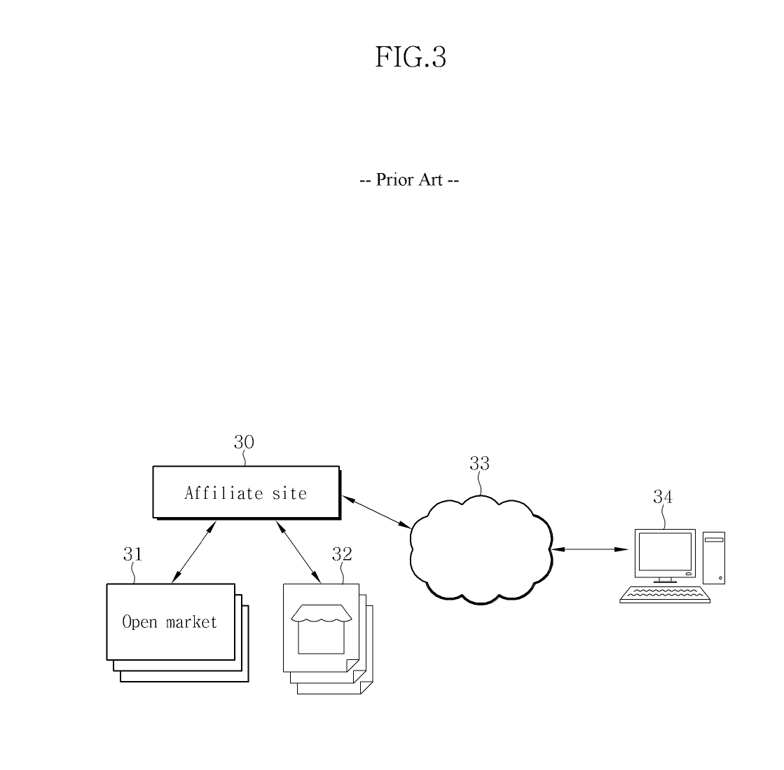

FIG. 4 shows an example of exchange of cyber money among users belonging to a group.

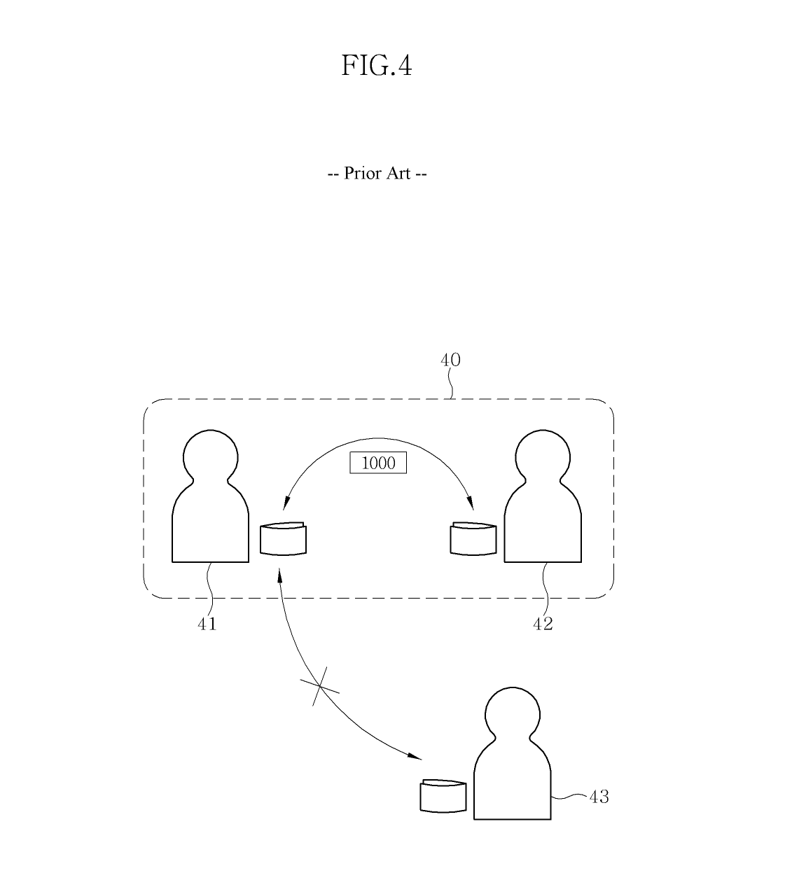

FIG. 5 is a conceptual view for explaining the concept of an operation of an embodiment of the present invention.

FIG. 6 is block diagram showing a configuration of an embodiment of the present invention.

FIG. 7 is a screen view showing an example of representation according to an embodiment of the present invention.

FIG. 8 shows an example of a payment scheme and reward provision according to an embodiment of the present invention.

FIG. 9 shows an example of sharing of a shared item according to an embodiment of the present invention.

FIG. 10 shows an example of selection of advertisement-combined goods according to an embodiment of the present invention.

FIG. 11 shows an example of goods alteration according to an embodiment of the present invention.

FIG. 12 is a flow chart showing a goods purchase procedure according to an embodiment of the present invention.

FIG. 13 is a flow chart showing a multi-payment procedure according to an embodiment of the present invention.

### DETAILED DESCRIPTION OF THE PREFERRED EMBODIMENT

Hereinafter, embodiments of the present invention will be described in detail with reference to the accompanying drawings.

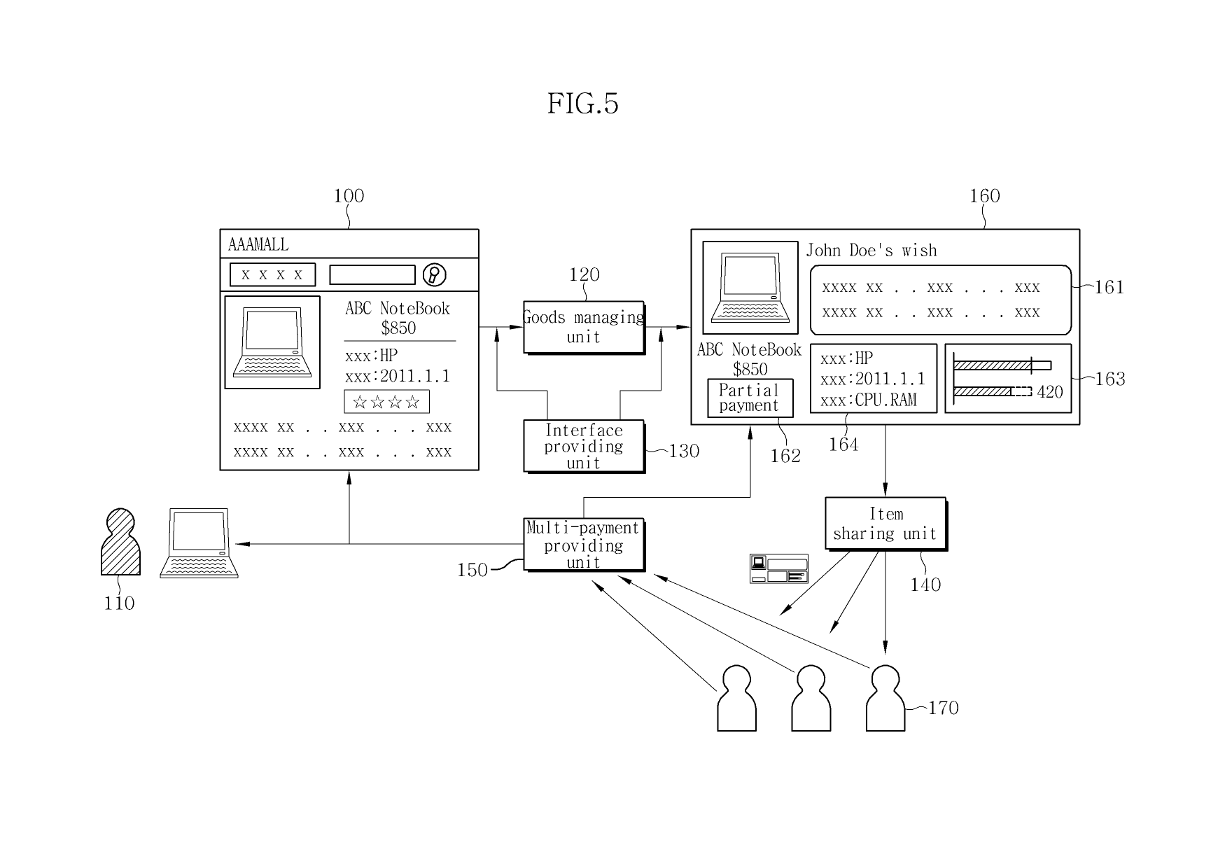

FIG. 5 is a conceptual view used to explain the concept of operation of an embodiment of the present invention. As shown, when a purchase wisher 110 registers the contents and settings for desired goods, as goods information, through a goods managing unit 120 from a sales screen 100 of a service provider which provides a commerce service for goods, an interface providing unit 130 generates a sharing item 160 by combining information registered through an interface to the multi-payment providing unit 150 for multi-payment and the goods managing unit 120, and an item sharing unit 140 provides the sharing item 160, as information in the format which can be registered in a social network, to the purchase wisher 110. When the purchase wisher 110 uses social network information directly or the item sharing unit 140 uses pre-registered social network information of the purchase wisher to share the sharing item 160 through the social network, the sharing item 160 is exposed to multiple social network participants 170 including acquaintances of the purchase wisher and unspecified multiple social network participants 170 make payments for partial amount of money in goods price through an interface 162 of the multi-payment providing unit 150 include in the exposed sharing item 160. When the accumulative amount of multi-payment reaches the goods price, the multi-payment providing unit 150 acts as a proxy for goods purchase through a commerce service provider actually selling the goods, thereby allowing the goods to be delivered to the purchase wisher 110.

Of course, the multi-payment providing unit may provide the commerce service provider with money except for commission after goods delivery is first requested and then completed in the purchase proxy.

Here, in addition to the multi-payment providing interface 162 for basic contents including a goods photograph, goods price and multi-payment, the sharing item 160 may include a message for the cause or purpose of goods purchase by the purchase wisher 110 and individual impressions on the goods, specifications of the goods 164, contextual information 163 indicating target money and present payment context, etc.

The message 161 is preferably prepared by the purchase wisher 110 through the goods managing unit 120. Such an individual message of the purchase wisher 110 can provide an increased possibility of purchase due to increased concentration of the social network participants 170 on the goods.

On the other hand, the contextual information 163 indicating the current context of payment can be provided in different forms and the target payment money accumulated through the multi-payment may not be fixed to the goods price. For example, if the purchase wisher 110 sets $600 in the goods price of $850 to the target money and the accumulated payment money reaches the target money, it can be set for the purchase wisher 110 to pay the remaining $150 when the goods is registered through the goods managing unit 120.

Thus, since it is specified that the money paid by the payer is to be used for any purchase wisher to purchase what goods, it can be clearly seen that any goods is presented as a gift. For example, for an introduced goods that an acquaintance known through a social network just wants to have, when a portion of the goods price is paid so much as his/her acquaintance, the purchase wisher can clearly know who responds to the purchase wisher's purchase hope, and the payer can also know that the payer makes contribution to the goods purchase for the purchase wisher so much as the paid money, thereby allowing for providing and receiving good wills based on a social relationship with little burden.

The above-described embodiment shows excellent effects for donations as well as typical gifts. For example, instead of simply donating money which is unknown where it will be used for an untrusted organization, by participating in purchase of particular required goods (for example, 100 boxes of ramens, 1000 bottles of mineral water, etc., to be offered to any refugees) and directly paying a portion of cost incurred to purchase the goods, it is easy to grant a motivation to donation even for an untrusted organization increase a degree of satisfaction of a donator. In addition, since money can be donated so much as desired through partial payment, the donator may obtain a satisfaction to get a help to provide any goods for anywhere, although small donation, which can be a big help for activation of donation.

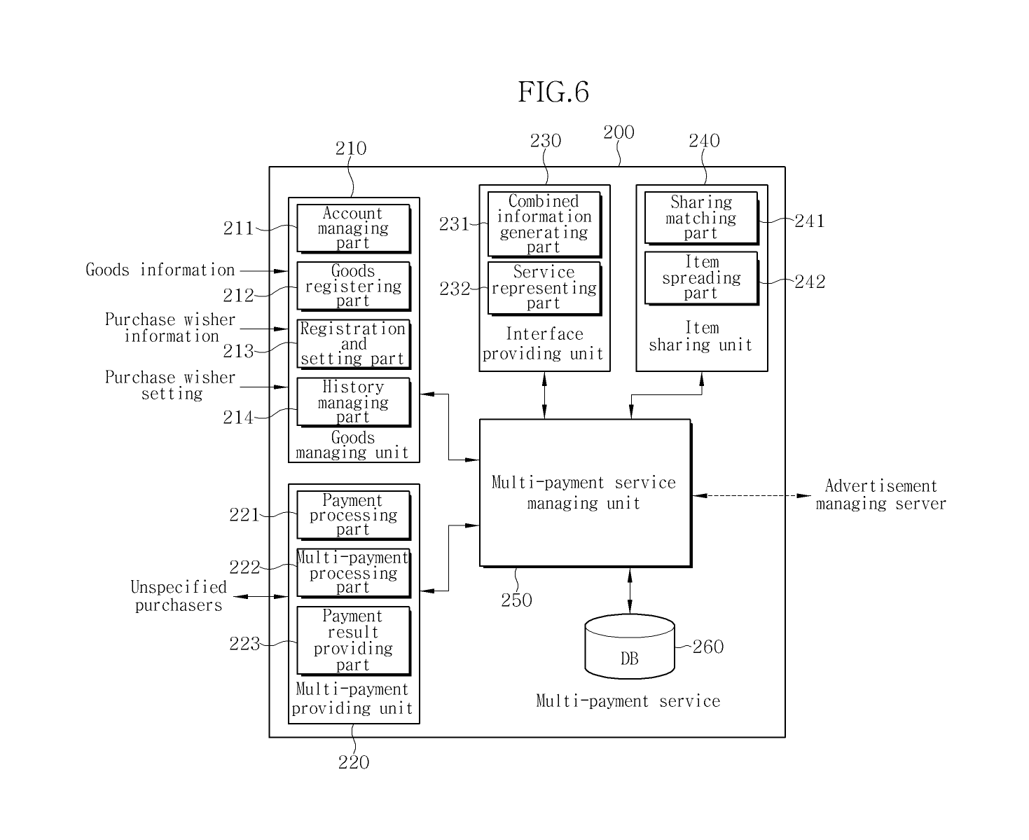

The configuration of the above embodiment will be described in more detail below with reference to FIG. 6.

FIG. 6 is a block diagram showing the configuration of the embodiment. This block diagram may be reconfigured in terms of functions and configuration in different forms from the shown embodiment. It is noted that some of the functions may be modified, omitted or replaced with different functions and, therefore, the present invention is not limited to this block diagram.

The shown configuration includes a multi-payment service unit 200 according to another embodiment of the present invention. The multi-payment service unit 200 includes a goods managing part 210 which receives information including target money for goods (including services) to be purchased, registers the information as goods information, and manages a history for the goods, a multi-payment providing part 220 which acts as a proxy for purchase for the goods by processing partial payments for the goods registered in the goods managing part 210 up to the target money, an interface providing part 230 which generates goods information registered in the goods managing part 210 and shared item information including an interface providing the function of the multi-payment providing part 220, an item sharing part 240 which provides the shared item information provided through the interface providing part 230 in a format which can be shared through a social network, and a multi-payment service managing part 250 which delivers information provided through the above-mentioned parts and reads/writes related information from/into an internal or external database 260.

In the meantime, since the multi-payment service may be advertised, the multi-payment service managing part 250 can associate with an external advertisement managing server and may contain an advertisement managing server as necessary.

The goods managing part 210 may include an account managing portion 211 which registers accounts of purchase wishers or payers through membership joining and collectively manages history of registered goods, payment contexts, goods purchase contexts, shared item sharing contexts, usable cyber money and so on, a goods registering portion 212 which registers contents of goods specified by a purchase wisher having a registered account and performs alteration, deletion and so on as necessary, a registration setting portion 213 which registers and alters various settings (for example, target money, individual payment limit in multi-payment, payment money, exposure period, exposure time, purchase wisher's message and so on) for the goods desired by the purchase wisher, and a history managing portion 214 which manages a history for goods, a history for accounts and so on.

The goods managing part 210 can use an Open API of a service provider platform providing a commerce service for the goods to allow the purchase wisher to obtain information on a selected purchase object, thereby enhancing purchase wisher's convenience and, as necessary, can provide an input webpage for receiving information or a message (a purchase wisher's message provided to a payer) for goods and an input webpage for various settings. In addition, the goods managing part 200 can acquire goods information from a service provider screen providing a commerce service for the goods through one of various ways including webpages, widgets, toolbars, multiple frames, links and mobile applications, provide contents pre-registered for the goods and an ongoing payment procedure, and perform an edition.

In addition, the goods managing part 210 can acquire goods contents (from off-line or a service provider screen providing the commerce service) by using QR code or bar code recognition, RFID tag identification, optical character recognition (OCR) and the like through recent widely used mobile devices or separate peripheral devices. That is, some of mobile applications can be used and new goods information can be recognized through a widget or a toolbar.

The multi-payment providing part 220 may include a payment processing portion 221 which is called through an interface provided in the shared item and allows unspecified social network participants to make a partial payment for the goods price, a multi-payment managing portion 222 which provides a money limit paid through the payment processing portion 221 on the basis of payment environments (settings for target money, goods price, discount, points, cyber money and so on) set for the goods, determines whether or not accumulated payment money reaches the target money of the payment environments, and performs payment for the goods according to the set payment environments, and a payment result providing portion 223 which verifies whether or not goods delivery is made according to the payment for the goods, and notifies (which means providing a result manually through a shared item) or informs (which means providing a result message through a payer's social network or e-mail, SMS of a mobile terminal, or the like) payers of the completion of goods purchase.

The payment processing portion 221 can pay preset money or money set by a payer through at least one of credit payment, charge-integrated payment of communication or broadcasting means, cyber money or point payment, on-line transfer, bank account transfer and coupon payment. This makes payment easy even when a payer is not subscribed in the multi-payment service and make easy payment through cyber money commonly used internally if the payer is subscribed in the multi-payment service.

The interface providing part 230 may include a combined information generating portion 231 which generates a shared item by combining the goods information registered through the goods managing part 210 and an interface for the multi-payment providing portion 223, and a service representing portion 232 which can adjust detailed configuration and arrangement for the shared item as necessary.

The item sharing part 240 may include a sharing matching portion 241 which provides the shared item generated in the interface providing part 230 in a format (a link, a tag, an image including a link, a flash, an XML, a widget, a webpage or the like) which can be easily inserted in accordance with a limitation on the type of social networks to share the shared item, and an item spreading portion 242 which automatically spreads contents including the shared item based on information on the social network of the purchase wisher (type of the social network, access information and so on).

The database 260 can store user account information, goods-related order information, registered goods information, payment-related information, sharing-related information and other information, and the multi-payment service managing part 250 manages information for various parts including the above-described goods managing part 210, multi-payment providing part 220, interface providing part 230 and the item sharing part 240 in a proper mutual exchanging manner and also manages reading/writing of the database 260.

In the meantime, the goods managing part 210 can adjust the target money for the pre-registered according to an account access of the purchase wisher and can complete multi-purchase with the target money set to a current state. That is, the purchase wisher can purchase the goods with summation of his/her own payment money and money multi-paid for a certain period. In this case, proxy purchase can be accomplished as the purchase wisher pays a difference between the accumulated multi-payment money and the goods price. In addition, the accumulated multi-payment money can be delivered to the purchase wisher after the purchase wisher purchases the goods directly and confirms that the multi-payment service unit 200 is informed of a result of the purchase.

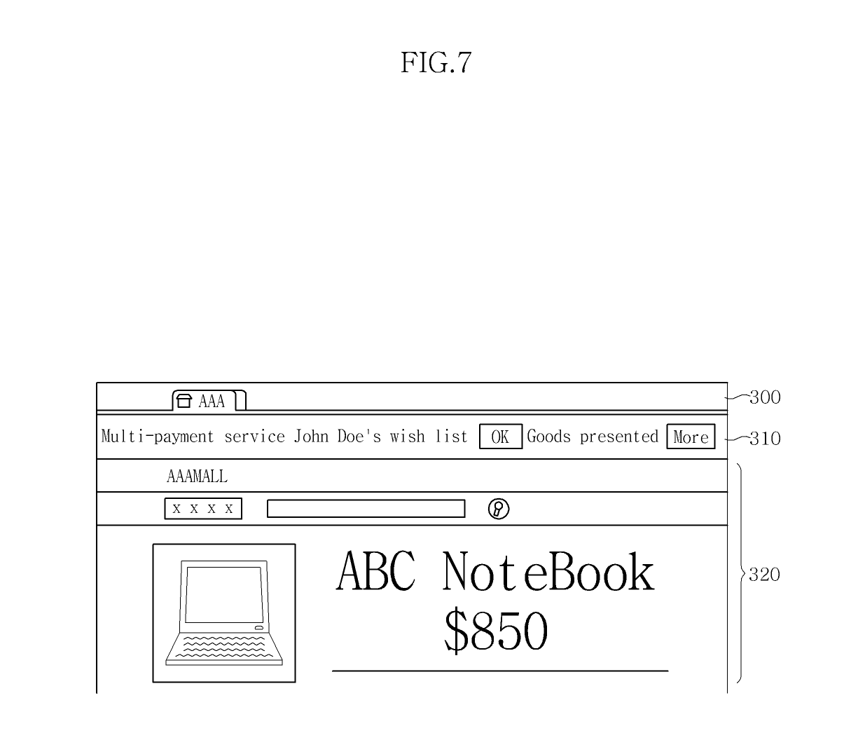

FIG. 7 is a screen view showing an example of representation according to an embodiment of the present invention. As shown, when a new goods is registered or information in a pre-registered goods is to be confirmed through the multi-payment service unit 200, the goods managing part 210 of the multi-payment service unit 200 can be represented on a top frame through a multi-frame of a browser 300 as shown, in which case a goods sales screen 320 of the exist typical commerce service provider is indicated on a bottom frame. The top frame 310 of the goods managing part can acquire information on the goods through an Open API of the commerce service provider or can acquire contents of the goods through a process of analyzing the bottom frame to extract required information. This can make a goods registration procedure relatively easy.

This multi-frame can be applied without any separate program and, as necessary, can install an additional program associated with a browser or use a widget or the like.

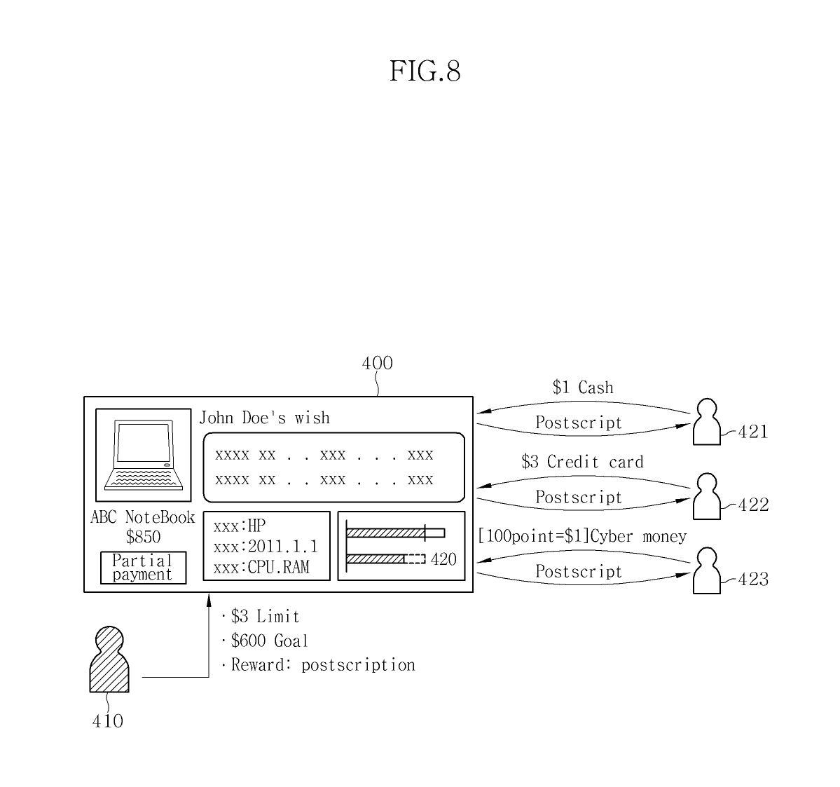

FIG. 8 shows a payment scheme according to an embodiment of the present invention and a case where rewards are provided to payers when a purchase wisher purchases goods with multi-payment. As shown, several unspecified payers 421 to 423 who confirm a shared item 400 can pay some of the goods price with cash, credit cards, cyber money and the like through multi-payment in different ways. In addition to this payment scheme, partial payment is possible through different payment schemes such as different kinds of moneys and summation of communication fees. In some cases, cyber money which is commonly used in different groups and can be exchanged in real money through the groups later may be used.

In the end, the partial payment scheme for the goods price through multi-payment can encompass a majority of currently used payment means such as credit payment, charge-integrated payment of communication or broadcasting means, cyber money or point payment, on-line transfer (including transfer brokerage service such as Paypal or the like), bank account transfer, coupon payment and other payments.

In the meantime, as shown, the purchase wisher can add various settings in registration of goods with the contents of the shared item 400. For example, an upper limit of payment can be limited to $3 to prevent a payer from feeling any burden, or alternatively, the purchase wisher may set a target money lower than the goods price (for example, set the target money to $600 in the goods price of $850) and may bear a difference. In addition, if a purchase is made, certain rewards may be promised to payers. For example, when subsequent utilization states for goods purchased with helps such as sharing a postscript for use of the goods, posting analysis contents, certified photos or moving pictures, etc., are provided, the payers 421 to 423 participated in the payment may feel a higher sense of intimacy to a response of the purchase wisher 410 to a result of the payment in which the payers participated. Of course, any penalty may be imposed on the purchase wisher if the purchase wisher does not keep such rewards for a certain period of time. Whether or not such rewards are kept can be determined through a method of registering rewards contents in the multi-payment service unit or collecting authentication information of payment participants. This can be achieved through the multi-payment providing part.

The shown example shows a case where it is set that the purchase wisher 410 provides use postscript for the goods as a reward for the purchase, in which contents of the postscript can be specified in the shared item 400. The payers 421 to 423 who confirm this shared item 400 and participate in the payment can be informed of contents of the confirmation if the purchase is basically made and can confirm postscript registration provided as a reward.

In order to compel this reward more, when the purchase wisher completes the goods purchase, makes a reward and informs the multi-payment service unit of a result of the reward, the multi-payment service unit can automatically or manually confirm the reward and accordingly can provide the accumulated multi-payment money to the purchase wisher. Accordingly, the proxy purchase method may be varied depending on the kind and importance of rewards.

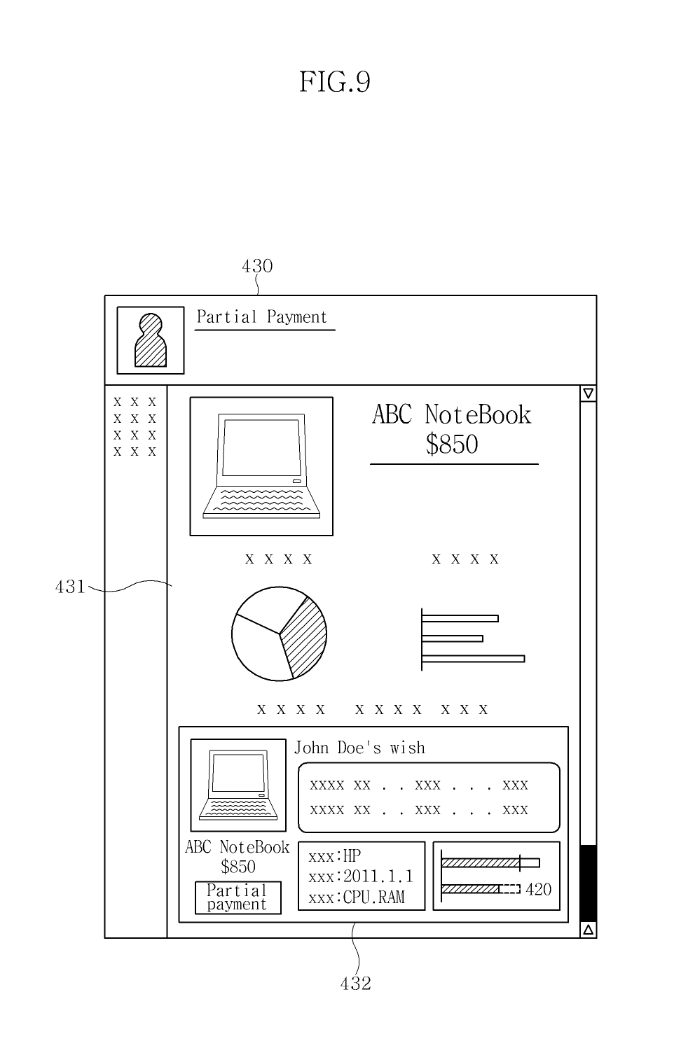

FIG. 9 shows an example of a shared item according to an embodiment of the present invention. As shown, a shared item 432 is shared through a blog 430 which is a kind of social network. When the shared item 432 is included in blog contents 431 and is registered, the shared item 432 can be confirmed by an acquaintance who frequently visits the blog, a visitor having an interest similar to that of a purchase wisher being an administrator of the blog, or a visitor interested in the contents. Of course, even when the contents are copied and moved to a different place (which is called ‘scrapping’), the shared item 432 is moved together. Accordingly, the better the contents 431 of the blog, the more widely the shared item 432 can be spread. In addition, if the blog contents 431 are related to goods requested to be purchased through the shared item 432, visitors will be highly interested in the shared item 432 and accordingly the number of payers will increase, which may make it easier to reach the goal. That is, not only is goods information of the shared item 432 shared, but also can be the goods information shared through social network contents. This provides a room for utilization as a kind of target advertisement to increase the level of interest related to the goods.

In other words, as a purchase wisher having a higher level of intimacy to acquaintances or social network participants having similar interest inserts a message intended for purchase of the goods in the shared item and positive contents related to the goods in the social network contents are shared to the social network participants having similar interest, the positive interest in the goods can be maximized to achieve the purpose of advertisement. In addition, since a user (a multi-payment service member) having an interest in goods through the shared item 432 can easily add the goods to his/her own wish list, a shared item for direct goods purchase or multi-payment can be easily generated. That is, a multi-payment service interlocking link is put on the shared item 432 and can be used in the goods managing unit for different users who request for the goods information of the shared item 432.

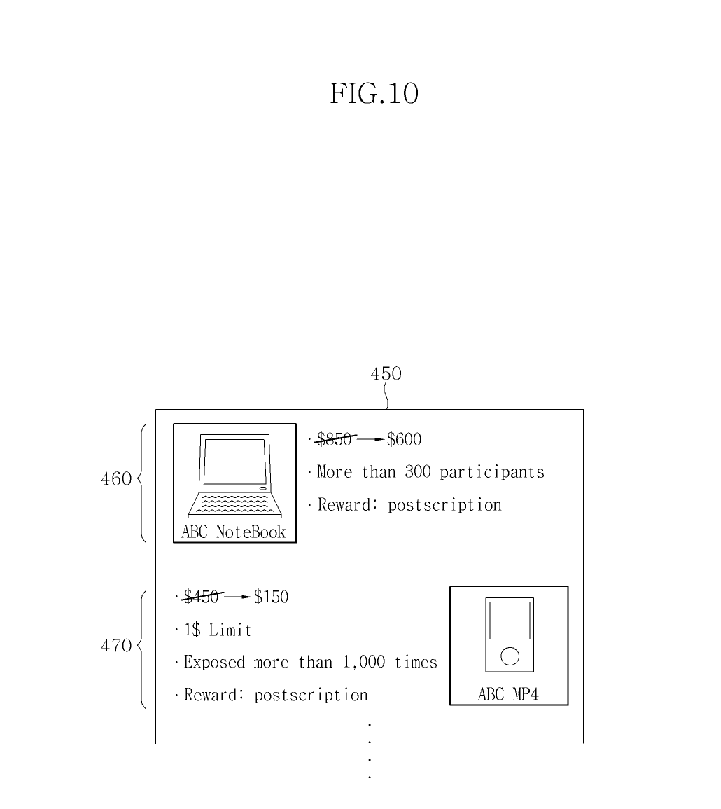

FIG. 10 shows an example of selection of advertisement-combined goods according to an embodiment of the present invention, which is capable of actively maximizing a passive advertising effect. This example may be one new social commerce method in which an advertiser is induced to share goods intended for advertisement as a shared item and discount is made if a predetermined condition is satisfied.

For example, the shown advertising goods list 450 clearly shows the content that a notebook computer 460 is discounted from $850 to $600 under the condition that the number of multi-payment participants is more than 300 and a purchase wisher prepares a postscript as a reward after purchase, and the content that a multimedia player 470 is discounted from $450 to $150 under the condition that multi-payment money is limited to $1, the shared item is exposed to different visitors or social network participants by at least 1000 times, and the purchase wisher prepares a postscript after purchase.

For the purpose of application of these detailed advertisements, the multi-payment service managing part of the multi-payment service unit can collect relevant information from an external advertisement managing server and can present this information to members and the multi-payment providing unit can be configured such that payment environments can be varied depending on satisfaction of the corresponding conditions if goods included in the advertisement content is desired to be purchased. In addition, the multi-payment service managing part can deliver the condition information set in the advertisement to the multi-payment providing part which then can set a payment state depending on the payment environments. In addition, the multi-payment providing part can collect and analyze the sharing state information of the shared item in different ways in order to a change in the payment environments, which may be independently configured. For example, the number of payers may be accumulated in payment or the number of exposures or exposed positions of the shared item at a request of payment may be confirmed, thereby allowing the payment state to be varied.

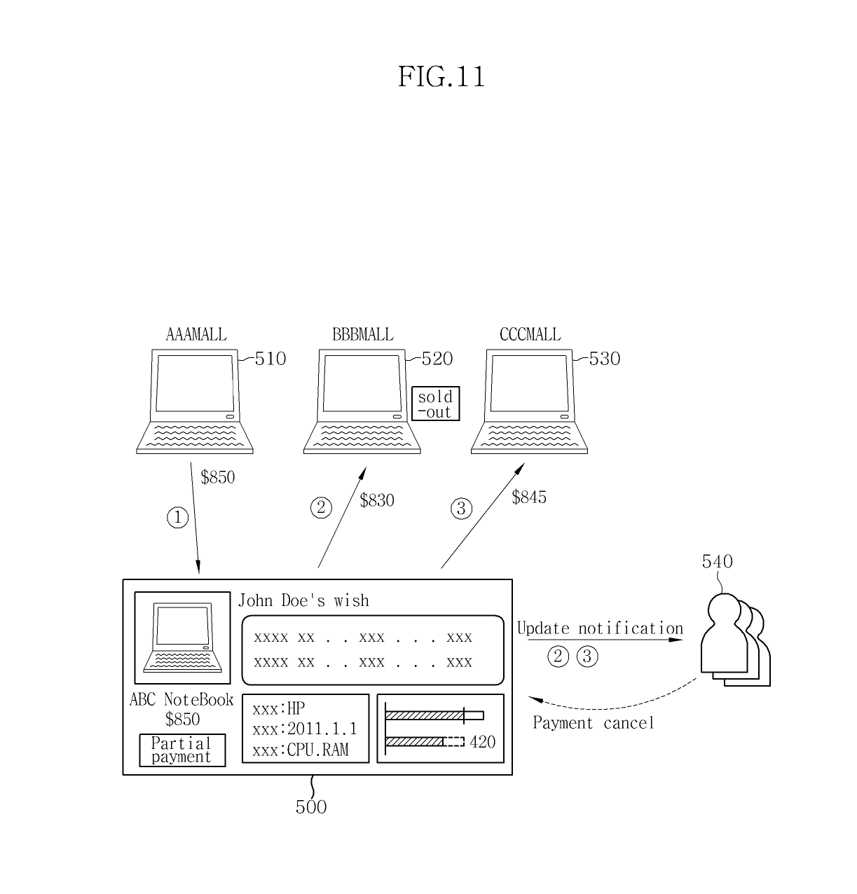

FIG. 11 shows an example of goods alteration according to an embodiment of the present invention. As shown, under a situation where a shared item 500 is generated and shared for registered goods desired to be purchased in a first on-line shopping mall 510, if it is known that the same goods is sold with lower expense, a goods link for the same goods can be changed. On the other hand, if a seller stops selling the goods or the goods are sold-out before reaching desired target money, the goods can be replaced with goods in a different shopping mall 530 although its price is higher. When information on the goods to be sold is changed in this course, payers 540 to the present can be informed of such update. In some cases, the payers 540 can cancel payment content if purchase is not yet made.

In the embodiment of the present invention, since multiple payers pay for goods desired by a purchase wisher, it is preferable to set a limitation to prevent the purchase wisher from changing the goods arbitrarily. For example, there may be a limitation such as allowing different similar goods to be selected only if the same goods is allowed to be changed to cheaper goods or is unavailable due to sold-out.

On the other hand, if accumulated payment money does not reach the target money in a preset period of time or goods purchase is not possible due to sold-out, it is preferable that paid money is basically returned to payers. In addition, if payment is hard to be cancelled due to use of different kinds of payment methods, the money for the payment can be replaced with cyber money that can be used like cash or general-purposed cyber money that can be commonly utilized in various places. In the other hand, even when purchase is failed in payment according to selection of a payer, the payment money can be provided to the purchase wisher in the form of cyber money.

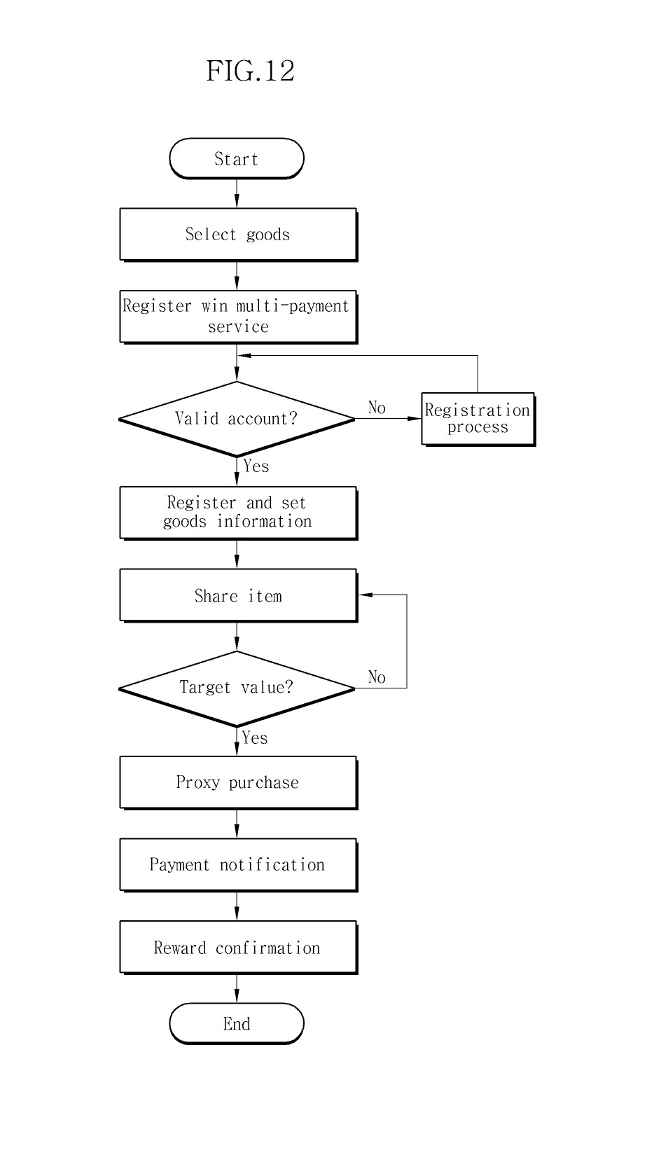

FIG. 12 is a flow chart showing a goods purchase procedure according to an embodiment of the present invention. As shown, a purchase wisher selects goods from any goods sales site and requests a multi-payment service to register the goods.

The multi-payment service unit verifies whether or not an account of the purchase wisher is valid and, if valid, registers goods information such as goods content, setting and so on. If the account of the purchase wisher is invalid, a valid account is generated through a new registration procedure.

When a shared item is generated and provided by a combination of the registered goods information and an interface of the multi-payment providing unit, the purchase wisher shares the shared item through a social network. For example, the shared item can be implicitly or explicitly spread to acquaintances, participants having personal connections, unspecified individuals, etc.

When an accumulation of partial payments through the multi-payment interface of the shared item reaches the target value through the sharing of the shared item, the multi-payment participants are informed of the fact that proxy purchase for the goods is made using the accumulated payment money and payment for the goods purchase is made. Thereafter, if the purchase wisher has set a reward when the purchase was made, it is confirmed that the reward is made and the purchase procedure for the goods is ended.

Although not shown, if the purchase has been not yet made, the payment of the multi-payment participants may be cancelled or may be replaced with different kinds of rewards and then the purchase procedure for the goods is ended.

On the other hand, although the goods purchase proxy is unconditionally made in the above embodiment, purchase proxy in other embodiments may be meant to include a direct purchase procedure by a purchase procedure in order to cope with variety of environments such as different kinds of goods, different payment environments, conditions of combination with advertisement, etc. In the embodiments of the present inventions, ‘purchase proxy’ is preferably construed to manage the overall procedure from starting to ending of purchase while enabling multi-payment in the purchase procedure for particular goods. That is, although the subject of the verification process for order and receipt of goods and the subject of goods price payment at a particular point of time may be either the multi-payment service part or the purchase wisher, since start of the overall goods purchase and final verification of purchase/reward are performed by the multi-payment service part, ‘purchase proxy’ mentioned in the embodiments of the present invention has a comprehensive meaning.

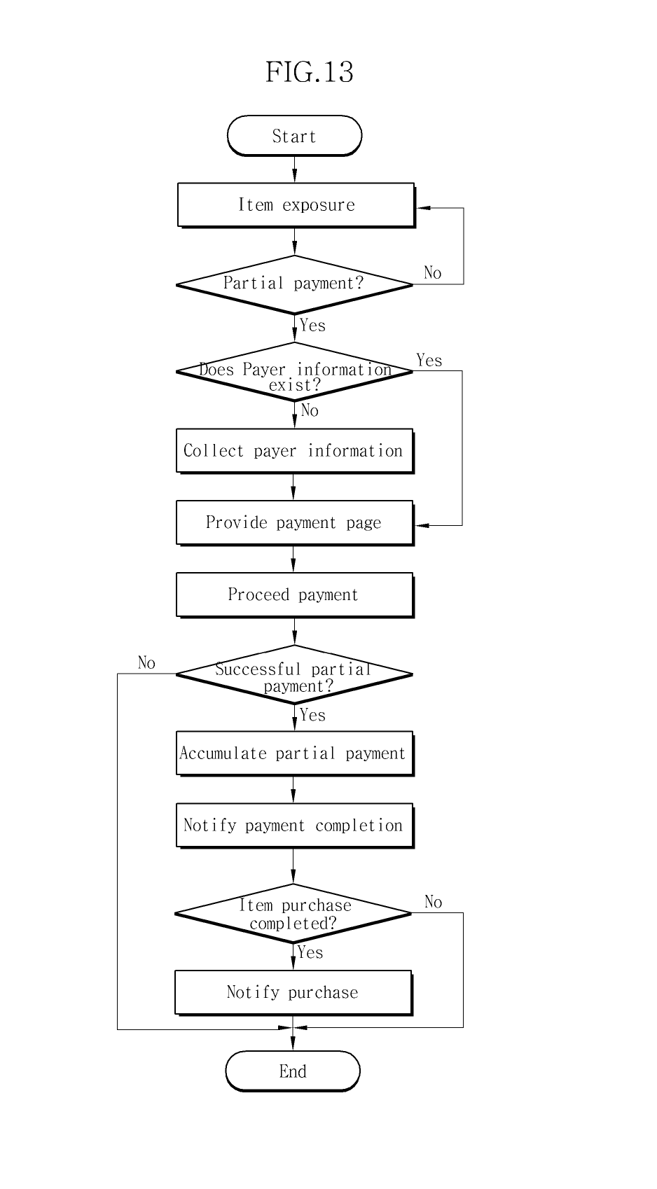

FIG. 13 is a flow chart showing a multi-payment procedure according to an embodiment of the present invention. As shown, when a social network participant who confirms a shared item selects a multi-payment providing part interface of the shared item, partial payment can be performed. If a payer is a member registered in the multi-payment service or has previously made payment, that is, if there exists information on the payer, the payer information can be collected. For example, information such as identifiable names, for example, the payer's name, ID or nickname, payment type, method and information of recovery of payment money in purchase failure, contact for notification of a purchase result, etc. can be collected and membership registration of the multi-payment service may be requested.

If there exists necessary information related to the payer as described above, a payment page can be provided to progress payment. The payment method may be diversified as described previously.

As a result of this payment progress, if the payment is successful, the partial payment moneys are accumulated and the payer is informed of the completion of payment, accumulated payment money information, etc.

When the accumulated money to the present reaches the target money, purchase for the goods is made and the payment participants are informed of the fact.

Through the above-described embodiments, a purchase wisher can obtain partial supports required for goods purchase from unspecified individuals without exposing his/her detailed personal information, while payers can explicitly express their good will to the purchase wisher through payment of a level which imposes little burden and directly confirm a result of the payment, which may result in high reliability.

Although the description of the above embodiments has been made mainly on the basis of PCs (Personal Computers) and Web, it is to be understood that this description can be equally applied to mobile environments including mobile devices, mobile networks and so on.

While the present invention has been particularly shown and described with reference to exemplary embodiments thereof, it will be understood by those skilled in the art that various changes in form and details may be made therein without departing from the spirit and scope of the present invention. The exemplary embodiments are provided for the purpose of illustrating the invention, not in a limitative sense. Thus, it is intended that the present invention covers the modifications and variations of this invention provided they come within the scope of the appended claims and their equivalents.

What is claimed is:

1. A system for proxy purchasing through multi-payment comprising:
a goods managing part which receives information on a purchase object, registers the information, and manages a history for the object;
a multi-payment providing part which accumulates partial payments of multiple payers for the purchase object registered in the goods managing part and performs purchase for the purchase object;
an interface providing part which generates purchase object information registered in the goods managing part and shared item information including an interface for the multi-payment providing part;
an item sharing part which provides the shared item information provided through the interface providing part in a format which can be shared in a social network; and
a multi-payment service managing part which delivers information provided through the above parts and reads/writes related information from/into an internal or external database.

2. The system according to claim 1, wherein the goods managing part uses an Open API of a service provider platform providing a commerce service for the purchase object to obtain information on a selected purchase object.

3. The system according to claim 1, wherein the goods managing part provides an input webpage which receives the information on the purchase object.

4. The system according to claim 1, wherein the goods managing part acquires the object information from a service provider screen providing a commerce service for the object through one of various ways including widgets, toolbars, multiple frames, links and mobile applications.

5. The system according to claim 1, wherein the goods managing part provides at least one of payment-related settings including a payment method for multi-payment for the purchase object, payment limit money and target money, and at least one of description input means including a specification of the purchase object, description on the purchase object and a message to be delivered to payers.

6. The system according to claim 1, wherein the multi-payment providing part pay preset money or money set by a payer through at least one of credit payment, charge-integrated payment of communication or broadcasting means, cyber money or point payment, on-line transfer, bank account transfer and coupon payment.

7. The system according to claim 1, wherein the multi-payment providing part notifies or informs payers, who participate in multi-payment for the purchase object, of information on completion of purchase for the purchase object.

8. The system according to claim 1, wherein the interface providing part provides the shared item information in one or more sharable forms depending on a preset kind or format.

9. The system according to claim 1, wherein the item sharing part provides the shared item generated in the interface providing part in at least one of formats including a link, a tag, an image including a link, a flash, an XML, a widget and a webpage in proper matching in accordance with a limitation on the type of social networks to share the shared item.

10. The system according to claim 1, wherein the item sharing part uses social network information of a purchase wisher registering the purchase object to automatically register the shared item information in the social network.

11. The system according to claim 1, wherein the goods managing part further includes a setting portion which receives a kind of reward to be provided to a payer for purchase of the object when the purchase object is registered, and confirms whether or not the reward is made based on a result of the purchase of the multi-payment providing part.

12. The system according to claim 1, wherein the multi-payment service managing part acquires preset advertisement information for the purchase object, provides condition information on advertisement in goods registration through the goods managing part, and sets payment environments by providing the condition information to the multi-payment providing part.

13. The system according to claim 12, wherein the multi-payment providing part collects sharing state information of the shared item and changes the payment environments based on the condition information for the advertisement.

14. The system according to claim 1, wherein the goods managing part provides a means for varying, for the same goods, a service provider or a seller providing a commerce service for the purchase object.

15. A system for proxy purchasing through multi-payment comprising:
a goods managing part in which goods information including sales information on purchase wish goods and message information of a purchase wisher;
a multi-payment providing part which accumulates payments of partial money for goods registered through the goods managing part and performs payment for the goods when the accumulated partial money reaches target money or there is a selection of the purchase wisher; and
an interface providing part which provides shared item information including a portion of goods information registered through the goods managing part and an interface for the multi-payment providing part in a format which can be shared in a preset kind of social network.

16. The system according to claim 15, wherein the goods managing part collects and stores the purchase wish goods in the form of a wish list and allows only a selected one of the purchase wish goods to be paid through the multi-payment providing part.

17. The system according to claim 15, wherein the interface providing part further includes an interface, which provides information on goods included in the shared item to the goods managing part, in the shared item.

18. A method for proxy purchasing through multi-payment comprising:
a goods registering step of receiving and registering, as goods information, goods content wished for purchase through an account of a purchase wisher and set information designated by the purchase wisher;
an item generating step of generating a shared item by combining a multi-payment interface performing partial payment for the goods registered through the goods registering step with the goods information;
an item sharing step of providing the generated shared item in a format which can be shared through a preset kind of social network; and
a payment step of accumulating partial payments through the multi-payment interface included in the shared item and making proxy purchase for the goods when the accumulated partial payments reach a goal or at a point of time desired by the purchase wisher.

19. The method according to claim 18, wherein the item sharing step includes exposing multiple goods, which are registered in the goods registering step through a single shared item shared in the social network, according to a preset exposure method.

20. The method according to claim 18, wherein the payment step includes notifying or informing payers, who participate in the multi-payment, of information on completion of purchase after proxy purchase for the goods.
